(19) United States
(12) Patent Application Publication
(10) Pub. No.: US 2002/0150783 A1
(43) Pub. Date: Oct. 17, 2002

(54) Deformable coated wick liquid spilled material transfer

(76) Inventors: Gareth Geoffrey Hougham, Ossining, NY (US); Keith Edward Fogel, Mohegan Lake, NY (US); Donald Thomas DeMouth, Danbury, CT (US)

Correspondence Address: Alvin J. Riddles, Box 34, Candlewood Isle, New FairField, CT, 06812, US

(21) Appl. No.: 09/834,848

(22) Filed: Apr. 13, 2001

(51) Int. Cl. B32B 15/02; A62D 3/00; B23P 17/06

(52) U.S. Cl. 428/605; 588/231

(57) ABSTRACT

Spilled, difficult to handle material can be transferred from the spillage location through the use of a deformable absorber member that has a thin surface coating that has a high affinity for the spilled material. The deformable absorber may be provided with a large spilled material receiving surface area through being formed of a group of contacting particles or intertwined filaments that impart a wicking capability with respect to a spillage in liquid form. The invention is of particular use in the cleaning up of spilled mercury droplets using a woven copper wick member coated with a thin layer of gold.

### FIELD OF THE INVENTION

The invention is in the field of the handling of spilled materials and in particular to the collection and transfer of such materials.

### BACKGROUND AND RELATION TO THE PRIOR ART

In the handling of materials, situations occur where it becomes necessary to transfer a spilled quantity of a material from the location where the spillage occurred to a different location and in some instances to storage. With some materials considerable environmental concerns may be involved.

At the present state of the art the liquid metal mercury is a material where there is a need for a means to clean up and transfer spilled quantities. The metal mercury has many valuable properties but in many environments where it is, could be used, the ability for immediate and facile cleanup of spillage is also needed. Such environments would include home, hospital and laboratory settings. In many of such settings the spillage is the result of a broken element of an apparatus so that the conditions under which the cleanup must be conducted may be quite difficult.

The mercury cleanup arrangements that are presently available are generally inadequate. Such arrangements typically use such items as zinc metal powders and pressed particle sponges used in attempts to amalgamate with the spilled mercury. There is minimal interaction with the mercury and minimal absorption of any significant quantity. Another technique used in laboratories is to sprinkle with elemental sulfur. With this technique minimal volume is absorbed and care must be used with the sulfur after the absorption. Some mechanical approaches to the problem use an eye dropper which loses benefit as the droplets become smaller and further any eyedropper that has been used would then also require handling care.

### SUMMARY OF THE INVENTION

Spilled material can be transferred from the spillage location through the invention involving the use of a member having a thin surface coating of a metal that has a high affinity for the spilled material. The spill transfer member may be provided with a large, spilled material receiving surface area, through being formed of contacting coated particles or intertwined filaments that impart a wicking capability with respect to a liquid. The invention is of particular use in the cleaning up of spilled mercury droplets using a woven copper wick member coated with a thin layer of gold.

### BRIEF DESCRIPTION OF THE DRAWINGS

FIGS. 1 and 2 are schematic cross sectional views of the thin surface coating interface in the invention, wherein:

FIG. 1 illustrates a supporting member with a surface area coating of a material with an for the spilled material.

FIG. 2 illustrates a supporting member with a layer of material capable of bonding with the spilled material and covered with a surface area coating of a material with an affinity for the spilled material.

FIG. 3A is a perspective view of a cross section of a particle serving as a supporting member having a spilled material affinity coating on the surface.

FIG. 3B is a perspective and end cross section of a filament serving as a supporting member having a spilled material affinity coating on the surface.

FIG. 4A is a perspective view of the structural features for a particle wicking transfer element of the invention in transferring a spilled material from a location on a surface, and,

FIG. 4B is a perspective view of the structural features for a filament wicking transfer element of the invention in transferring a spilled material from a location on a surface.

### DESCRIPTION OF THE INVENTION

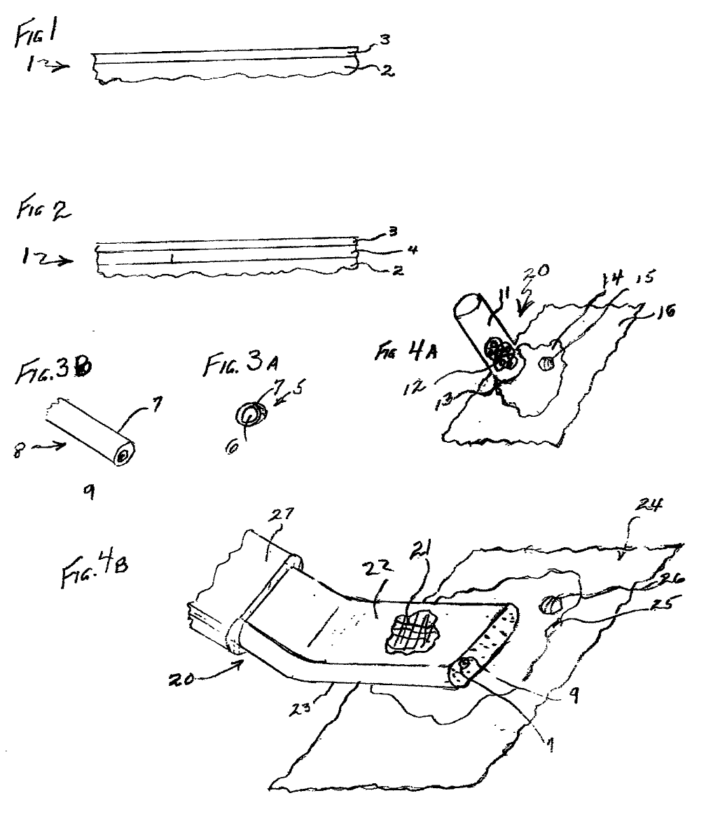

In the invention a spilled material transfer element is made up of a deformable supporting member on which a coating of a material with a high affinity for the spilled material is provided. For clarity in illustration the situation involving the liquid metal mercury is used throughout the explanation. It will however be apparent that the principles of the invention may further be applied to the spillage of any material that will readily wet a coating of a material that has a high affinity for the spilled material. A spillage of mercury is readily cleaned up when a copper supporting member coated with a thin coating of gold is used to collect the mercury. Referring to FIG. 1, in the invention the transfer element for spilled material 1 is made up of a deformable supporting member 2 on which is provided a thin coating 3 of a material that has an affinity for the spilled material that is to be transferred.

The coating 3 of a material that has an affinity for the spilled material being transferred is an essential ingredient. In some instances, the materials that have an affinity for another, are more expensive and will store lower volumes of the spilled material, than are materials that merely bond to the being transfered material. As an example, for the material mercury there are a number of materials that will amalgamate, such as members of the group of copper, zinc and silver, but there few if any materials that have an affinity for the mercury that is as high as gold.

Referring to FIG. 2, in some situations it can be useful to provide a layer 4 of a material or materials that will form a chemical bond with the, being transferred, material. Such a structural feature permits a larger volume of the spilled material to be transferred and stored, while not requiring a large thickness of the high affinity material layer 3.

In the situations of FIGS. 1 and 2 the supporting member 2 can provide a greater surface area if a particle or filamentary structure is employed wherein each supporting member is provided with a thin coat of a material that has a high affinity for the material that was spilled.

The thin coat of a material that has a high affinity for the material that was spilled is illustrated in connection with FIGS. 3A and 3B.

Referring to FIG. 3A the support member 2 is a granule of powder or a particle 5 with an inner portion 6 that is material that will amalgamate with the spilled material such as a member of the group of copper, silver and zinc, and surrounded by a thin coating 7 of a material that has a high affinity for the spilled material such as gold.

Referring to FIG. 3B the support member 2 is a filament 8 with an inner filamentary portion 9 that is material that will amalgamate with the spilled material such as a member of the group of copper, silver and zinc, and surrounded by a thin coating 7 of a material that has a high affinity for the spilled material such as gold.

The application of the coating 7 on the various support shapes lends itself to such techniques as plating, electroless plating, sputtering and vacuum deposition.

Where the affinity material coated particles or filaments are or assembled into a contacting volume, substantial quantities of a spilled material can be transferred by a wicking action.

In the practice of the invention the principles can be efficiently applied through the use of an arrangement where the transfer element 1 is configured as a hand tool with some deformation capability for interfacing with a surface. The principles for the hand tool configuration, labelled element 20, are illustrated, for the situation where the support member 2 is in particle form in FIG. 4A, and where the support member 2 is in filamentary form in FIG. 4B.

Referring to FIG. 4A the hand tool 20 is arranged as a cylindrical tube 11, of generally cigarette size of an inert material that will deform to facilitate a conforming contacting interface labelled element 13 with the surface 16, and into which a quantity 12 of contacting coated particles 5 have been placed. A portion of the quantity 12 of the contacting coated particles 5 are visible through the breakaway view of the tube 11. On the surface 16 there is depicted a spillage area 14 with an illustrative droplet 15. The contacting quantity 12 of coated particles at the interface 13 at the area 14 provides a wicking action in the collection of the spilled material.

Referring to FIG. 4B the hand tool 20 in which the supporting member 2 has deformability imparted by being fabricated of a braid 21 of deformable metal filaments 8, over which is provided a coating 7 of a material with a higher affinity for the spilled material. The braid 21 is shown in a breakaway through the inert cover 22 as a woven mat as an example. The end of the braid at 23 is shown shaped or deformed to provide a broader contact with the surface 24 on which in the area of the spilled material 25, there is shown at least one example droplet 26. A conforming plastic sleeve 27, of for example thermally shrinkable material well known in the art, is provided for handling the spilled material.

Further, considering for illustration purposes, the situation where the spilled material is the liquid metal mercury, and a hand tool 20 of braided filaments 21 is used. In such a situation following the illustration of FIG. 4B, the mercury usually covers an area 25 on a surface 24 and frequently agglomerates into many, varying size, droplets such as 26. It thus may be necessary to be able to accommodate a considerable volume of the spilled material in order to thoroughly clean up the mercury and transfer it out of the area. The metallic wick tool 20 is highly effective in absorbing the mercury in difficult to reach areas.

In the invention where the deformable substrate a contacting quantity of particles or a braid of filaments such as a fine copper wire weave all coated with a thin outer coating of gold. The gold serves several purposes.

The main purpose of the gold is to have a material with a high affinity for the spilled material the mercury. The mercury has a high surface tension and few materials will wet it, the gold will.

A secondary purpose is to provide an outer metallurgy that prevents oxidation of other metals in the wick member which would reduce their effectiveness in amalgamating with the mercury. While gold can amalgamate with the mercury and can, when deposited on and into the interstices of contacting particles or a filament mat, provide a large capacity for absorption of mercury, but since gold is expensive on a weight basis, it may be preferable to use only a very thin layer of gold to enhance wetting and use a less expensive amalgamating metal such as copper, zinc or silver for an underlayer as shown as element 4 in FIG. 2 to provide the bulk of the amalgamating and thus bind a large volume of mercury.

The high affinity for the spilled material coating, such as the gold, being amenable to application through such techniques as plating, electroless plating, vacuum evaporation and sputtering, readily enters the interstices of such substrates as a quantity of contacting particles, a wire braid, a mat of filaments, sponge material frits, and metal powders so as to provide a large surface area for a relatively small volume of the high affinity material gold.

A sputter deposition coating of gold about 5000 angstroms thick on an about two and one half inch long section of a one half inch copper wire braid in bundles of five to seven with about one half inch of the braid extending beyond a shrink wrap tubing handling member, provides a satisfactory mercury spillage transfer tool.

What has been described is a technique and tool for the transfer of spilled material, such as mercury, away from a spillage location, wherein a deformable support member is provided, having a thin surface coating of a metal that has a high affinity for the spilled material. Where the spilled material is mercury, a thin surface coating of gold is very effective.

What is claimed is:

1. A transfer tool for the collection and transporting of a spilled material from a spillage area comprising:
a deformable substrate member having deposited on the surface thereof a coating of a material having a high affinity for said spilled material.

2. The transfer tool of claim 1 wherein said spilled material is mercury.

3. The transfer tool of claim 2 wherein said deformable substrate member with said coating of high affinity for said spilled material, is a structure of coated members taken from the group of a contacting quantity of particles, woven and matted filaments, metal powders and particle sponges.

4. The transfer tool of claim 3 wherein said deformable substrate member with said coating of high affinity for said spilled material, is a structure of coated metal members in at least one of particle or filamentary form and taken from the group of copper, zinc and silver.

5. The transfer tool of claim 4 wherein said coating of a material having a high affinity for said spilled material is gold.

6. In the transferring of spilled material through the use of an intermediate absorber member for the spilled material, the improvement comprising:
a deformable absorber member in a form of at least one of a contacting quantity of particles and a filamentry arrangement and the interstices of said absorber being coated with a thin coating of a material having a high affinity for said spilled material.

7. The improvement of claim 6 wherein said spilled material is mercury.

8. The improvement of claim 7 wherein said material having a high affinity for said spilled material is gold.

9. The improvement of claim 8 wherein the material in said deformable absorber are of metal taken from the group of copper, zinc and silver.

10. The improvement of claim 9 wherein said deformable absorber is at least one braid of copper wires.

11. In the handling of spilled material through transfer from the spillage location, the improvement comprising:
the use of a deformable absorber member with a thin surface coating of a material that has a high affinity for said spilled material.

12. The improvement of claim 11 wherein said deformable absorber member is at least one of a quantity of contacting particles and intertwined filaments that impart a wicking capability with respect to a spillage in liquid form.

13. The improvement of claim 12 wherein said deformable absorber member is at least one braid of woven copper wires.

14. The improvement of claim 13 wherein said deformable absorber member is contacting quantity of particles supported in an inert tubular holder.

15. The improvement of claim 12 wherein said spilled material is mercury and said elements of said deformable absorber member are coated with gold
